(19) United States
(12) Patent Application Publication
(10) Pub. No.: US 2020/0103902 A1
(43) Pub. Date: Apr. 2, 2020

(54) COMFORTABLE RIDE FOR AUTONOMOUS VEHICLES

(71) Applicant: GM GLOBAL TECHNOLOGY OPERATIONS LLC, Detroit, MI (US)

(72) Inventor: Maria John Paul Dominic, Sterling Heights, MI (US)

(73) Assignee: GM GLOBAL TECHNOLOGY OPERATIONS LLC, Detroit, MI (US)

(21) Appl. No.: 16/147,953

(22) Filed: Oct. 1, 2018

(51) Int. Cl. G05D 1/02; G01C 21/34

(52) U.S. Cl. CPC G05D 1/0212; G01C 21/3484; G05D 2201/0213; G05D 1/0231; G05D 1/0257; G05D 1/0276

(57) ABSTRACT

Systems and method are provided for controlling an autonomous vehicle. In one embodiment, a method includes: receiving sensor data sensed from an environment of the autonomous vehicle; receiving comfort data indicating a comfort level of a user of the autonomous vehicle; determining a vibration level based on the sensor data; build a map of vibration data based on the vibration level and an association with a geographic location of a road; selecting a lane for travel along the road based on the map; and controlling the autonomous vehicle to travel in the selected lane when following a route.

### INTRODUCTION

The present disclosure generally relates to autonomous vehicles, and more particularly relates to systems and methods for selecting lanes of a path that the autonomous vehicle will travel based on cloud vibration data.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

The vehicle navigates the environment based on a path that is determined for the vehicle to travel. In some instances, when the vehicle travels along the determined path, the vehicle may encounter road features that are undesirable to a passenger. For example, pot holes, rock or dirt roads, or other surfaces that may cause vibration in the vehicle may be undesirable to a passenger.

Accordingly, it is desirable to provide systems and methods for controlling the path of the vehicle based on vibration data. It may be further desirable to determine the vibration data with the autonomous vehicle and to collect the vibration data from multiple vehicles in a cloud. Furthermore, other desirable features and characteristics of the present disclosure will become apparent from the subsequent detailed description and the appended claims, taken in conjunction with the accompanying drawings and the foregoing technical field and background.

### SUMMARY

Systems and method are provided for controlling a vehicle. In one embodiment, a method includes: receiving sensor data sensed from an environment of the autonomous vehicle; receiving comfort data indicating a comfort level of a user of the autonomous vehicle; determining a vibration level based on the sensor data; building a map of vibration data based on the vibration level and an association with a geographic location of a road; selecting a lane for travel along the road based on the map and the comfort data; and controlling the vehicle to travel in the selected lane when following a route.

In various embodiments, the method includes determining the geographic location and associating the vibration level with the geographic location.

In various embodiments, the method includes determining an overall vibration level based on the vibration level and other vibration levels determined by other autonomous vehicles, and wherein the building the map is based on the overall vibration level.

In various embodiments, the determining the overall vibration level is performed by a system remote from the autonomous vehicle and the overall vibration level is communicated from the remote system to the autonomous vehicle.

In various embodiments, the determining the overall vibration level is performed by the autonomous vehicle.

In various embodiments, the sensor data includes vehicle data that indicates vibration of the autonomous vehicle.

In various embodiments, the sensor data includes occupant perception data that indicates an occupant's perception of vibration while in the autonomous vehicle.

In various embodiments, the sensor data includes at least one of lidar data, radar data, and image data associated with a road surface in the environment of the autonomous vehicle.

In various embodiments, the comfort data includes a maximum level, a minimum level, or a range of comfort values indicated by the user of the autonomous vehicle.

In another embodiment, a system for controlling an autonomous vehicle is provided. The system includes: a sensor system configured to sense data from an environment of the autonomous vehicle; and a control module configured to receive the sensor data, receive comfort data indicating a comfort level of a user of the autonomous vehicle, determine a vibration level based on the sensor data, build a map of vibration data based on an association of the vibration level with a geographic location of a road, select a lane for travel along the road based on the map and the comfort data, and control the autonomous vehicle to travel in the selected lane when following a route.

In various embodiments, the control module is further configured to determine the geographic location, and associate the vibration level with the geographic location.

In various embodiments, the control module is further configured to determine an overall vibration level based on the vibration level and other vibration levels determined by other autonomous vehicles, and to build the map based on the overall vibration level.

In various embodiments, the system includes a system remote from the autonomous vehicle and configured to determine an overall vibration level based on the vibration level and other vibration levels determined by other autonomous vehicles and communicate the overall vibration level to the control module.

In various embodiments, the control module is of the autonomous vehicle.

In various embodiments, the sensor data includes vehicle data that indicates vibration of the autonomous vehicle.

In various embodiments, the sensor data includes occupant perception data that indicates an occupant's perception of vibration while in the autonomous vehicle.

In various embodiments, the sensor data includes at least one of lidar data, radar data, and image data associated with a road surface in the environment of the autonomous vehicle.

In various embodiments, the comfort data includes a maximum level, a minimum level, or a range of comfort values indicated by the user of the autonomous vehicle.

In another embodiment, a transportation system is provided. The system includes: at least one autonomous vehicle configured to receive the sensor data, receive comfort data indicating a comfort level of a user of the autonomous vehicle, determine a vibration level based on the sensor data, build a map of vibration data based on an association of the vibration level with a geographic location of a road, select a lane for travel along the road based on the map and the comfort data, and control the autonomous vehicle to travel in the selected lane when following a route; and a system remote from the autonomous vehicle configured to receive the vibration level from the autonomous vehicle, receive other vibration levels from other autonomous vehicles, determine an overall vibration level based on the vibration level and the other vibration levels, and associate the overall vibration level with the map.

In various embodiments, the system remote from the autonomous vehicle is further configured to communicate the map including the overall vibration level to the autonomous vehicle and other autonomous vehicles.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a path prediction system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the path prediction system of the autonomous vehicle, in accordance with various embodiments; and

FIGS. 5 and 6 are flowcharts illustrating control methods for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

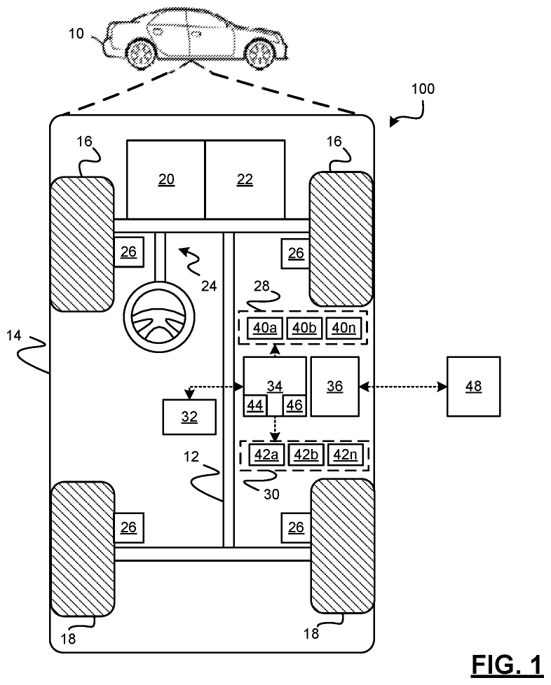

With reference to FIG. 1, a path prediction system shown generally at 100 is associated with a vehicle 10 in accordance with various embodiments. In general, the path prediction system 100 determines vibration data associated with an upcoming road. Based on the vibration data, the path prediction system 100 intelligently selects lanes for an upcoming path of the vehicle 10 and intelligently controls the vehicle 10.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the path prediction system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems (a GPS unit), optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

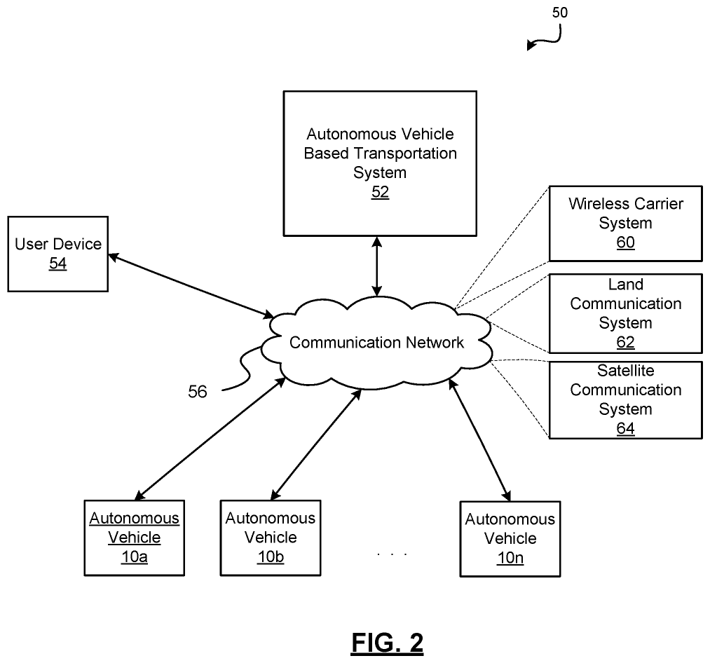

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the path prediction system 100 and, when executed by the processor 44, receive sensor data from the sensor system 28 and determine vibration data from the sensor data. The instructions further communicate the vibration data to a remote system and/or receive vibration data from the remote system. The instructions further determine a lane of travel for an upcoming path of the vehicle based on the vibration data that is received from the remote system and/or determined from the sensor system.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent sub scriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

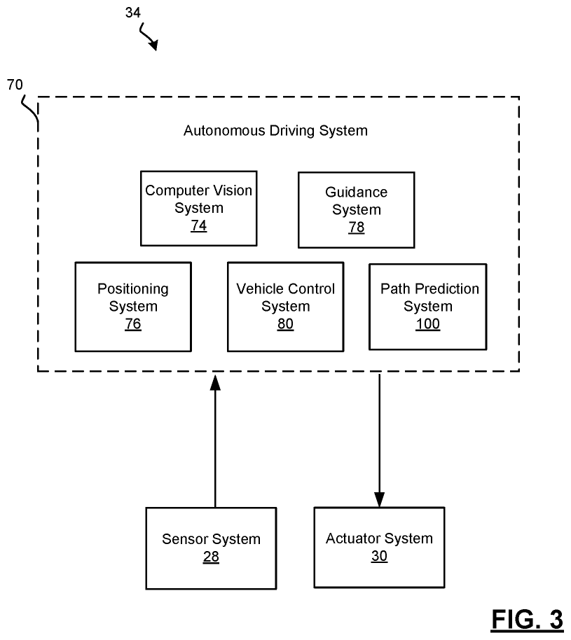

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the path prediction system 100 of FIG. 1 is included within the ADS 70, for example, as part of the computer vision system 74 and/or the guidance system 78 or as a separate system (as shown in the drawings).

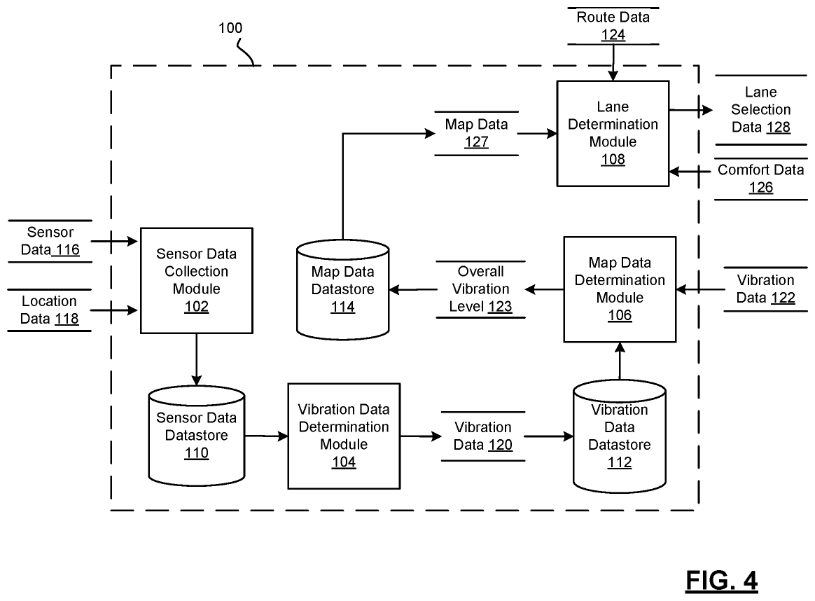

For example, as shown in more detail with regard to FIG. 4 and with continued reference to FIG. 3, the path prediction system includes a sensor data collection module 102, a vibration data determination module 104, a map data determination module 106, a lane determination module 108, a sensor data datastore 110, a vibration data datastore 112, and a map data datastore 114.

The sensor data collection module 102 receives sensor data 116 from the sensor system 28 including various sensors disposed about the vehicle 10 and stores the data for further processing. In various embodiments, the sensor data 116 includes vibration data sensed from the vehicle. In various embodiments, the vibration data is sensed from accelerometers associated with the vehicle. In various embodiments, the sensor data 116 includes environment data such as, but not limited to, image data representing images of road surfaces in proximity to the vehicle 10, radar data that includes radar returns from surfaces in proximity to the vehicle 10, and lidar data that includes lidar returns from surfaces around the vehicle 10. In various embodiments, the sensor data 116 includes vehicle data that may be used to indicate vibration such as, but not limited to, suspension system data that indicates movements of the suspension system in response to the road surface.

In various embodiments, the sensor data 116 includes occupant perception data that may indicate an occupant's perception of the vibration of the vehicle 10 such as, but not limited to, audio data including commentary from an occupant in relation to the road surface, and image data including a visual response from an occupant in relation to vibration from a road surface.

The sensor data collection module 102 determines a geographic location and associates the geographic location with the received sensor data 116. For example, when the sensor data 116 includes vibration data, vehicle data or occupant perception data, location data 118 can be received from the GPS unit. In another example, when the sensor data 116 includes environment data, the location data 118 can be received from the GPS unit and the sensor data collection module 102 adjusts the vehicle location by a distance determined to be between the vehicle 10 and the detected road surface. The received sensor data is associated with the determined geographic location and stored in the sensor data datastore 110 for further processing.

The vibration data determination module 104 retrieves from the sensor data datastore 110 the stored sensor data based on its association with a geographic location. The vibration data determination module 104 predicts a vibration level of the road surface for that geographic location based on the retrieved data. For example, the vibration level can be determined directly based on vibration data or accelerometer values. In another example, the vibration level can be adjusted based on the environment data, the occupant perception data, or vehicle data based on a weighted average or some other means.

In various embodiments, the vibration data determination module 104 determines the vibration level for each geographic location (e.g., x, y coordinate, or region associated with an x, y coordinate) in a defined area along a road, along roads of a route, along roads in a city or town, etc. and stores the vibration levels.

The map data determination module 106 retrieves the vibration data 120 from the vibration data datastore 112, and optionally receives vibration data 122 determined by other vehicles. The map data determination module 106 determines an overall vibration level for a given geographic location based on the vibration data 120 and optionally the vibration data 122 from other vehicles. For example, the map data determination module 106 may determine the overall vibration level based on a weighted average or of the vibration data 120, 122 associated with the same geographic location or by other computing means. The weights can be assigned based on the source of sensor data associated with the determined vibration level, the source of the vibration data 120, 122 (the vehicle 10 verses other vehicles), the time elapsed since the vibration data 120, 122 was computed, or any other variable.

The map data determination module 106 then associates and stores the overall vibration level with the map based on the geographic location. For example, an overall vibration level (e.g., either the computed or a null or zero) is stored for each geographic location on the map.

As can be appreciated, in various embodiments, the map data determination module 106 can be located remote from the vehicle 10 and can collect vibration data 122, 120 from many vehicles and can compute overall vibration levels based thereon. Such collection of computed overall vibration levels is referred to herein as cloud vibration data. The cloud vibration data can then be associated with a map of the environment; and the map of the environment can be communicated back to the vehicles as map data periodically, upon request, or in realtime.

The lane determination module 108 receives route data 124, and comfort data 126. The route data 124 indicates a planned route for the vehicle 10 and can be determined based on a pickup location and destination location entered by a user. The comfort data 126 indicates a comfort level of the user of the vehicle 10. The comfort level can indicate a maximum vibration, a minimum vibration, or a level associated with a range of vibration values (e.g., no preference, small, moderate, high, etc.). In various embodiments, the comfort data 126 may be entered by an occupant through a user interface either before the ride or during the ride.

The lane determination module 108 selects a lane for travel along the roads indicated in the route data and produces lane selection data 128. The lane determination module 108 retrieves map data 127 from the map data datastore 114 associated with the route indicated by the route data 124. The lane determination module then makes the selection of the lanes based on a comparison of the overall vibration levels 123 provided in the map data 127 and the comfort data 126. For example, if the map data 127 indicates that a road along the route has multiple lanes the comfort data 126 is compared to the overall vibration levels 123 in each lane and the lane satisfying the comfort data 126 is selected. When multiple lanes satisfy the comfort data 126 a lane determined to be fastest, most efficient, or other criteria may be selected. The lane determination module 108 generates lane selection data 128 based on the selected lanes. The lane selection data 128 may then be used by the guidance system 78 (FIG. 3) to determine the path of travel for the vehicle 10. The path of travel is then used by the vehicle control system 80 to control the vehicle 10 to the destination.

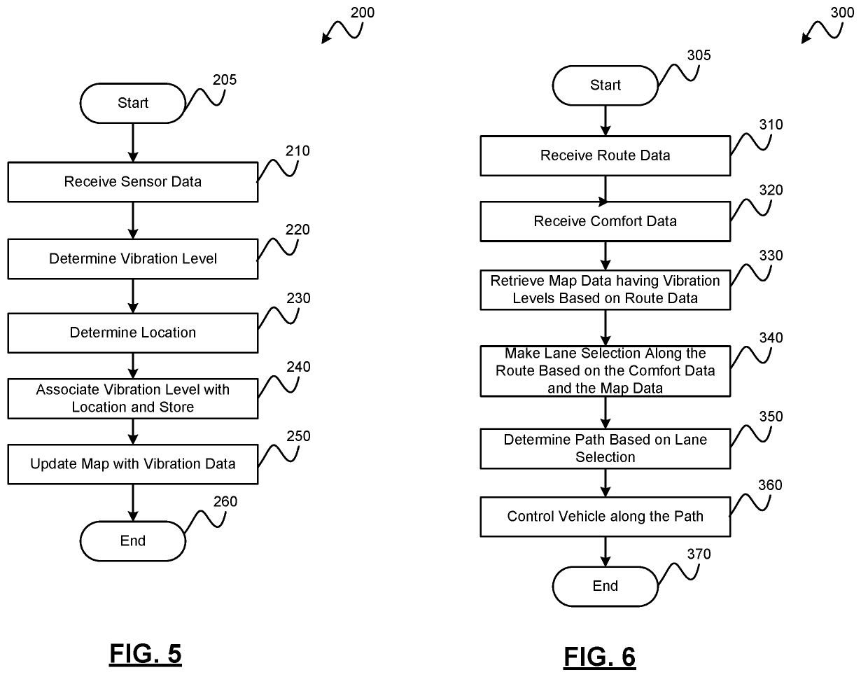

Referring now to FIGS. 5 and 6, and with continued reference to FIGS. 1-4, flowcharts illustrate control methods 200 and 300 that can be performed by the path prediction system 100 of FIG. 1 in accordance with the present disclosure. As can be appreciated in light of the disclosure, the order of operation within the method is not limited to the sequential execution as illustrated in FIGS. 5 and 6 but may be performed in one or more varying orders as applicable and in accordance with the present disclosure. In various embodiments, the methods 200, 300 can be scheduled to run based on one or more predetermined events, and/or can run continuously during operation of the autonomous vehicle 10.

In various embodiments, the method 200 is performed by the path prediction system 100 in order to maintain overall vibration levels within a map. In one embodiment, the method 200 may begin at 205. The sensor data 116 is received at 210 and the vibration level is determined at 220. The location data 118 is received and the geographic location of the vibration level is determined at 230. The geographic location is associated with the vibration level and stored as vibration data 120 in the vibration data datastore 112 at 240. The map stored in the map data datastore 114 is updated with the overall vibration levels 123 based on the geographic location at 250. Thereafter, the method may end at 260.

In various embodiments, the method 300 is performed by the path prediction system 100 in order to navigate the vehicle 10 based on the determined road vibration level and the desired comfort. In one embodiment, the method begins at 305. The route data 124 indicating the desired route is received at 310. The comfort data 126 indicating the desired comfort level is received at 320. The map data associated with the route provided by the route data 124 is retrieved at 330. The lanes selections are made along the route based on a comparison of the overall vibration levels 123 and the comfort data 126 at 340. The path is determined based on the lane selection data 128 at 350 and the vehicle 10 is controlled based on the path in order to navigate through the route at 360. Thereafter, the method may end at 370.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling an autonomous vehicle, comprising:
receiving sensor data sensed from an environment of the autonomous vehicle;
receiving comfort data indicating a comfort level of a user of the autonomous vehicle;
determining a vibration level based on the sensor data;
building a map of vibration data based on the vibration level and an association with a geographic location of a road;
selecting a lane for travel along the road based on the map and the comfort data; and
controlling the autonomous vehicle to travel in the selected lane when following a route.

2. The method of claim 1, further comprising determining the geographic location and associating the vibration level with the geographic location.

3. The method of claim 1, further comprising determining an overall vibration level based on the vibration level and other vibration levels determined by other autonomous vehicles, and wherein the building the map is based on the overall vibration level.

4. The method of claim 3, wherein the determining the overall vibration level is performed by a system remote from the autonomous vehicle and the overall vibration level is communicated from the remote system to the autonomous vehicle.

5. The method of claim 3, wherein the determining the overall vibration level is performed by the autonomous vehicle.

6. The method of claim 1, wherein the sensor data includes vehicle data that indicates vibration of the autonomous vehicle.

7. The method of claim 1, wherein the sensor data includes occupant perception data that indicates an occupant's perception of vibration while in the autonomous vehicle.

8. The method of claim 1, wherein the sensor data includes at least one of lidar data, radar data, and image data associated with a road surface in the environment of the autonomous vehicle.

9. The method of claim 1, wherein the comfort data includes a maximum level, a minimum level, or a range of comfort values indicated by the user of the autonomous vehicle.

10. A system for controlling an autonomous vehicle, comprising:
a sensor system configured to sense data from an environment of the autonomous vehicle; and
a control module configured to receive the sensor data, receive comfort data indicating a comfort level of a user of the autonomous vehicle, determine a vibration level based on the sensor data, build a map of vibration data based on an association of the vibration level with a geographic location of a road, select a lane for travel along the road based on the map and the comfort data, and control the autonomous vehicle to travel in the selected lane when following a route.

11. The system of claim 10, wherein the control module is further configured to determine the geographic location, and associate the vibration level with the geographic location.

12. The system of claim 10, wherein the control module is further configured to determine an overall vibration level based on the vibration level and other vibration levels determined by other autonomous vehicles, and to build the map based on the overall vibration level.

13. The system of claim 10, further comprising a system remote from the autonomous vehicle and configured to determine an overall vibration level based on the vibration level and other vibration levels determined by other autonomous vehicles and communicate the overall vibration level to the control module.

14. The system of claim 13, wherein the control module is of the autonomous vehicle.

15. The system of claim 10, wherein the sensor data includes vehicle data that indicates vibration of the autonomous vehicle.

16. The system of claim 10, wherein the sensor data includes occupant perception data that indicates an occupant's perception of vibration while in the autonomous vehicle.

17. The system of claim 10, wherein the sensor data includes at least one of lidar data, radar data, and image data associated with a road surface in the environment of the autonomous vehicle.

18. The system of claim 10, wherein the comfort data includes a maximum level, a minimum level, or a range of comfort values indicated by the user of the autonomous vehicle.

19. A transportation system, comprising:
at least one autonomous vehicle configured to receive the sensor data, receive comfort data indicating a comfort level of a user of the autonomous vehicle, determine a vibration level based on the sensor data, build a map of vibration data based on an association of the vibration level with a geographic location of a road, select a lane for travel along the road based on the map and the comfort data, and control the autonomous vehicle to travel in the selected lane when following a route; and
a system remote from the autonomous vehicle configured to receive the vibration level from the autonomous vehicle, receive other vibration levels from other autonomous vehicles, determine an overall vibration level based on the vibration level and the other vibration levels, and associate the overall vibration level with the map.

20. The transportation system of claim 19, wherein the system remote from the autonomous vehicle is further configured to communicate the map including the overall vibration level to the autonomous vehicle and other autonomous vehicles.
